(19) United States
(12) Patent Application Publication
(10) Pub. No.: US 2001/0015871 A1
(43) Pub. Date: Aug. 23, 2001

(54) Magnetic head, process for fabricating magnetic head and information recorder

(75) Inventor: Hideo Niwa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/735,365

(22) Filed: Dec. 12, 2000

(30) Foreign Application Priority Data
Feb. 23, 2000 (JP) 2000-046135

(51) Int. Cl. G11B 5/255

(52) U.S. Cl. 360/122

(57) ABSTRACT

A magnetic head having an accurately defined minute core width is provided. The magnetic head comprises a pair of soft-magnetic poles which are located adjacent to a magnetic disk and opposed to and apart from each other with a predetermined distance along a predetermined direction, and generates a magnetic field therebetween to magnetize the magnetic disk, wherein the upper magnetic pole 3 of the two magnetic poles has, at one end which is adjacent to the magnetic disk, a tip of a block form that has a front wall which is adjacent to the magnetic disk and a pair of side walls which extend in a direction perpendicular to the front wall as well as in the above-described predetermined direction, with the tip having an upper non-magnetic regions 3_{—}2 which has been formed by demagnetization by introducing impurity through each of the two side walls to a predetermined depth.

### BACKGROUND OF THE INVENTION

1. Field of the Invention

The present invention relates to a magnetic head for generating a magnetic field to magnetize an external medium, a process for fabricating the magnetic head, and an information recorder for recording information on a medium.

2. Description of the Related Art

Current diffusion of computers has increased the amount of daily information to be dealt with. One exemplary information recorder for recording such a large amount of information commonly used today is a hard disk drive (HDD). HDD typically has a magnetic disk, which is a disk-shaped medium on which information may be recorded, and a magnetic head to record information on the magnetic disk.

A magnetic disk has a ferromagnetic layer of which surface consists of ferromagnetic material, and retains independent magnetization in individual small regions on the ferromagnetic layer. The magnetic head is spinning at a high speed within the HDD during the operation of the HDD. The magnetic head has a small recording coil and a pair of magnetic poles, and is normally positioned adjacent to the magnetic disk which is spinning at such a high speed. The two magnetic poles are opposed to and apart from each other with a predetermined distance therebetween (gap length) along the direction toward which each track extends on the magnetic disk, and have a width almost equal and parallel to that of the track.

Once the recording coil of the magnetic head receives a signal current, the recording coil generates a recording magnetic field in response to the signal current, and the recording magnetic field flows out of the above-described two magnetic poles. Hereinafter, the magnetic width of recording magnetic field which flows out of a magnetic pole is referred to as a core width. Usually, a core width corresponds to the width of the magnetic pole of a magnetic head. Thus, the recording magnetic field which has flowed out will reverse the direction of the magnetization in each track on the surface of the magnetic disk in a small unit corresponding to the above-described gap length when required. Information may be recorded as the direction of magnetization in the individual small regions by such reversion of the magnetization.

HDD has been developed so as to improve the information recording density of a magnetic disk. In fact, the recording density has been improved year to year. Improved recording density can be attained, for example, by reducing the width of tracks on the magnetic disk. In this case, the above-described magnetic poles of the magnetic head are required to have a narrower core width corresponding to the decreased width of the tracks.

Conventionally, reduction in a core width has typically been attained by reducing the width of the magnetic pole by refining the magnetic pole. For refining such magnetic pole, techniques employed in the process for fabricating wiring of a semiconductor device or the like have been used. For example, a thin film (a magnetic pole) is exposed by using an i-ray or g-ray aligner and developed to form a resist pattern which is then used to trim the thin film to form a magnetic pole having a predetermined core width. Thus, the magnetic head formed can have a dimension of even smaller than 1 μm.

In the process for fabricating a semiconductor device, refinement of as small as about 0.2 μm has been realized by using fine pattern lithography techniques such as an excimer stepper. Application of the fine pattern lithography techniques to processes for fabrication magnetic head is now contemplated.

However, it has a lot of difficulties to apply the process for refining a semiconductor, which typically involves use of a resist having a thickness of less than 1 μm, directly to the process for fabricating magnetic head, which requires use of a resist having a thickness of 5 μm or more, to accomplish minute refinement of magnetic head as well.

For example, when a KrF excimer stepper, which is known to be useful for refining a semiconductor device, is used as an aligner, since use of chemical amplification-type resist is required for the KrF excimer stepper, which may cause problems such as rolling of the bottom of the resist or blind over edging. Such problems caused in the process for fabricating magnetic head may give uneven dimensions of the magnetic pole, resulting in reduced accuracy of the above-described core width. To solve these problems, intensive studies are required for developing materials and processes.

Alternatively, two-layer resist and three-layer resist processes are known as processes for a minute refinement of magnetic pole of a magnetic head. These processes are techniques in which a thick film resist, which is the bottom layer, is etched using an intermediate layer of SiO₂ resist or an upper layer of resist containing Si as a mask. Currently, however, reproducible refinement of a thick film resist along a vertical direction is too difficult to obtain a magnetic head having an accurate core width.

Alternatively, tip masking technique such as phase shift or half tone technique is also applied to refinement of a magnetic pole though none of these techniques could provide satisfactory result. Particularly, applying lithography technique to the process for refining a magnetic head in which a resist having a thickness as much as several μm may be used is very difficult today. Moreover, development of refining techniques for magnetic head is far quicker than that for semiconductor so that now it is not practical to apply the latter to the farmer. For these reasons, there is a strong demand for a process for fabricating magnetic head having a very precisely defined minute core width.

Accordingly, the object of the present invention is to provide a magnetic head having a very precisely defined minute core width, a process for fabricating the magnetic head, and an information recorder having the magnetic head.

### SUMMARY OF THE INVENTION

According to the present invention there is provided a magnetic head that comprises a pair of soft-magnetic poles which are located adjacent to a recording medium and opposed to and apart from each other with a predetermined distance in a predetermined direction, and generates a magnetic field therebetween to magnetize the recording medium; wherein

at least one of the magnetic poles has, at one end which is adjacent to or in contact with the recording medium, a tip of a block form that has a front wall which is adjacent to or in contact with the recording medium and a pair of side walls which extend in a direction perpendicular to the front wall as well as in the above-described predetermined direction, with the tip being formed by demagnetization by introducing impurity through each of the two side walls to a predetermined depth.

The magnetic head according to the present invention is positioned adjacent to or in contact with a recording medium such that the above-described predetermined direction typically goes, like conventional magnetic heads, toward the same direction as the direction toward which the track on which the head is positioned extends on the recording medium, and that the width direction of the tip of the upper magnetic pole (i.e., the width of the front wall of the tip which is a distance from one of the side walls to the other) is parallel to the width direction of the track.

The magnetic pole of the magnetic head according to the present invention has a tip having a magnetic width (i.e., the width of the upper soft-magnetic region of the tip) that is smaller than the actual width of the tip since the tip of the upper magnetic pole has been demagnetized from each of the side walls to a predetermined depth by introducing impurities as described above. Since the region of the magnetic head from which a magnetic field is flows out is defined by the magnetic region, then the magnetic head according to the present invention has a very narrow core width defined by the magnetic width of the tip.

The above-described magnetic head according to the present invention can also provide a tip having a reduced magnetic width throughout along the two side walls of the tip even when the side walls have broad surfaces since the tip has been demagnetized from each of the side walls to a predetermined depth by introducing impurities as described above.

Particularly, the magnetic head according to the present invention may have a tip of a height of 0.3 μm or more along the above-described predetermined direction, or with a thickness of 1 μm or more in the above-described direction perpendicular to the surface of the recording medium.

Conventional magnetic poles have a minute tip of which has been fabricated by reducing the width of one end of the magnetic poles using a physical or chemical process. Thus-produced tip may have varied width depending on points on the tip, and thus may have a core width with low accuracy. To the contrary, since the boundary between a region demagnetized and another region remained not-demagnetized by the above-described introduction of impurities may be flat as long as the side walls of the tip is flat, thus the magnetic head according to the present invention has a very accurately defined core width, which is defined by the width of the not-demagnetized region, even when the tip is too narrow.

Particularly, the magnetic head according to the present invention has a deviation within ±5% in the depth of the demagnetized region from each of the side walls, when the side walls of the above-described tip of a block form has a dimension of 0.3 μm or more at least along the above-described predetermined direction.

The magnetic head may have a pair of auxiliary magnetic poles provided on either or both of the above-described two magnetic poles on the side they face each other to control the spatial distribution of the magnetic field generated between the magnetic poles depending on the shape, size and material of the auxiliary magnetic poles. In this case, the above-described tip of the magnetic pole according to the present invention may be the end of the magnetic pole having such auxiliary magnetic pole(s) or may be such auxiliary magnetic pole(s) itself. Alternatively, the magnetic head according to the present invention may include trimmed portion or portions instead of such auxiliary magnetic pole(s). In this case, the above-described tip of the magnetic pole according to the present invention may be the end of the magnetic pole having such trimmed portion(s) or may be such trimmed portion(s) itself.

To accomplish these objects, the present invention also provides a process for fabricating magnetic head that comprises a pair of soft-magnetic poles which are located adjacent to or in contact with a recording medium and opposed to and apart from each other with a predetermined distance in a predetermined direction, and generates a magnetic field therebetween to magnetize the recording medium; wherein the process comprising the steps of:

forming one of the two magnetic poles, an upper magnetic pole having, at one end adjacent to or in contact with the recording medium, a tip of a block form that has a front wall which is adjacent to or in contact with the recording medium and a pair of side walls which extend in a direction perpendicular to the front wall as well as in the above-described predetermined direction; and

partly demagnetizing the upper magnetic pole formed in the step for forming upper magnetic pole by introducing ions through each of the side walls of the tip of the upper magnetic pole using ion-implantation.

In the above-described process for fabricating magnetic head according to the present invention, the above-described demagnetizing step may be preferably performed by introducing ions to the tip by applying ions downwardly in an angled direction with respect to each of the side walls when seen from the front of the tip.

Since the depth to which ions are injected by ion-implantation may generally be defined by the energy of ions (kinetic energy) and the angle at which ions are applied, the process for fabricating magnetic head according to the present invention can provide partial demagnetization of the tip of the magnetic head by introducing ions into the tip of the upper magnetic pole through each of the two side walls using ions having a predetermined energy and a predetermined injection angle thereby allowing the ions to be introduced to a predetermined depth. Thus, the process for fabricating magnetic head according to the present invention can provide a magnetic head having a very accurately defined minute core width by uniformly reducing the magnetic width along the side walls of the tip.

Some of conventional process for fabricating magnetic head also employs selective ion-implantation at a predetermined point on the magnetic pole(s) for various reasons and most of these ion-implantation procedures use a mask. However, ion-implantation processes using a mask require an accurate alignment of the mask to obtain a precisely defined core width of the minute magnetic pole. To the contrary, the above-described process for fabricating magnetic head according the present invention is of self-alignment type in which use of a mask or the like is not required, and can thus provide ion-implantation precisely in a desired portion on the magnetic pole or poles.

The process for fabricating magnetic head according to the present invention further comprise the step of forming the other magnetic pole, i.e., the lower magnetic pole. The procedure for forming the lower magnetic pole may preferably comprise demagnetizing the lower magnetic pole by the above-described demagnetization step by performing the ion-implantation into the tip through the side walls as well as into the lower magnetic pole at the same time by using an ion generator in the above-described demagnetizing step.

According to this process, the lower magnetic pole as well as the upper magnetic pole are partly demagnetized, and thus can have reduced width of its magnetic region.

Further, the above-described process for fabricating magnetic head according to the present invention may preferably comprise additional steps of:

forming the other magnetic pole, i.e., the lower magnetic pole;

forming a protecting film on at least one of the top surface of the tip of the upper magnetic pole (i.e., the surface of the tip facing opposite from the lower magnetic pole) and the top surface of the lower magnetic pole (i.e., the surface of the lower magnetic pole facing the upper magnetic pole); and

separating the protecting film or films formed in the step for forming a protecting film from the magnetic pole or poles; wherein the ion-implantation of the above-described demagnetizing step is performed after the step for forming a protecting film, followed by the step for separating the protecting film.

The process for fabricating magnetic head can prevent undesirable demagnetization of not-desired region due to introduction of ions through any other walls than the side walls of the tip of the magnetic pole.

To accomplish these objects, the present invention provides an information recorder comprising a magnetic head that is located adjacent to or in contact with a recording medium, which retains magnetization in individual small regions on its surface, and can reverse the direction of the magnetization on the recording medium to record the information in the individual small regions on the recording medium, wherein:

the magnetic head comprises a pair of soft-magnetic poles which are positioned adjacent to or in contact with the recording medium and opposed to and apart from each other with a predetermined distance in a predetermined direction, the soft-magnetic poles generate a magnetic field therebetween to magnetize the recording medium; and

at least one of the two magnetic poles has a tip of a block form adjacent to or in contact with the recording medium, the tip having a front wall adjacent to or in contact with the recording medium and a pair of side walls which extend in a direction perpendicular to the front wall as well as in the above-described predetermined direction, the tip having a non-magnetic region demagnetized by introducing impurities through each of the side walls to a predetermined depth.

This information recorder employs the above-described magnetic head according to the present invention. The magnetic head of the information recorder has, similarly to the above-described magnetic head according to the present invention, a precisely defined minute core width. Accordingly, the information recorder enables accurate recording of information in the individual tracks having a minute width on the magnetic disk, and thus is suitable for high-density recording.

### BRIEF DESCRIPTION OF THE DRAWINGS

FIG. 1 is a schematic view showing the hard disk drive according to the embodiment of the present invention.

FIG. 2 is a perspective view showing the main section of the magnetic head according to the embodiment of the present invention.

FIG. 3 is a front view showing the main section of the magnetic head according to the embodiment of the present invention.

FIG. 4 shows a first step of the process for fabricating magnetic head according to the embodiment of the present invention.

FIG. 5 shows a second step of the process for fabricating magnetic head according to the embodiment of the present invention.

FIG. 6 shows a third step of the process for fabricating magnetic head according to the embodiment of the present invention.

FIG. 7 shows an ion-implantation device which can be used for the process for fabricating magnetic head according to the embodiment of the present invention.

FIG. 8 is a diagram illustrating a distribution of ions which have been injected by ion-implantation.

FIGS. 9(A) and 9(B) is a front (A) and top (B) views showing the tip of an upper magnetic pole where ions have been introduced through the front surface by ion-implantation using a mask, respectively.

FIGS. 10(A) and 10(B) each is a front (A) and top (B) views showing the tip of an upper magnetic pole where ions have been introduced through the top surface by ion-implantation using a mask, respectively.

FIGS. 11(A) and 11(B) each is a front (A) and top (B) views showing the tip of an upper magnetic pole where ions have been introduced by ion-implantation of the process for fabricating magnetic head according to the embodiment of the present invention, respectively.

FIG. 12 shows one exemplary process for fabricating magnetic head according to the embodiment of the present invention.

### DETAILED DESCRIPTION OF THE PREFERRED EMBODIMENT

[Harddisk Drive]

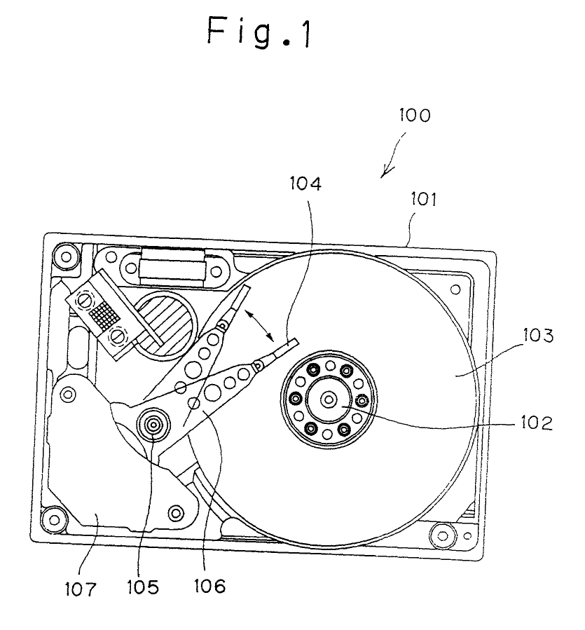

FIG. 1 shows the hard disk drive according to the embodiment of the present invention.

The hard disk drive (HDD) 100 shown in FIG. 1 corresponds to the information recorder of the present invention. The HDD100 comprises: a housing 101; a rotating spindle 102, a magnetic disk 103 attached to the rotating spindle 102; a floating head slider 104 opposed to the magnetic disk 103; an arm spindle 105; a carriage arm 106 which has the floating head slider 104 attached at one end thereof and pivots around the arm spindle 105 for horizontal movement over the magnetic disk 103; and an actuator 107 which drives the horizontal movement of the carriage arm 106. The housing 101 accommodates all the other components of the HDD100.

For recording and regenerating information on and from magnetic disk 103, actuator 107 comprising magnetic circuits drives carriage arm 106 which in turn locates floating head slider 104 on a desired track on the rotating magnetic disk 103. The floating head slider 104 is provided with a magnetic head (not shown in FIG. 1) which comprises a recording means to record information on the magnetic disk 103 and a regenerating means to regenerate information from the magnetic disk 103. The magnetic head is sequentially located adjacent to each of a series of one-bit regions arranged in each track on the magnetic disk 103 by rotation of the magnetic disk 103. The magnetic head may indirectly be contacted with the magnetic disk 103 with lubricant sandwiched therebetween. For recording information, an electric recording signal is transmitted to the magnetic head located adjacent to the magnetic disk 103, the recording means of the magnetic head in turn applies a magnetic field to each of these one-bit regions in response to the recording signal, and then the information carried on the recording signal is recorded in each of these one-bit regions in a form of the direction of magnetization. For regenerating information, the information recorded in a form of the direction of magnetization in each of these one-bit regions is retrieved as an electric regeneration signal produced in response to the magnetic field generated from the magnetization by the regenerating means of the magnetic head. Internal space of the housing 101 is enclosed by a cover (not shown).

[Magnetic Head]

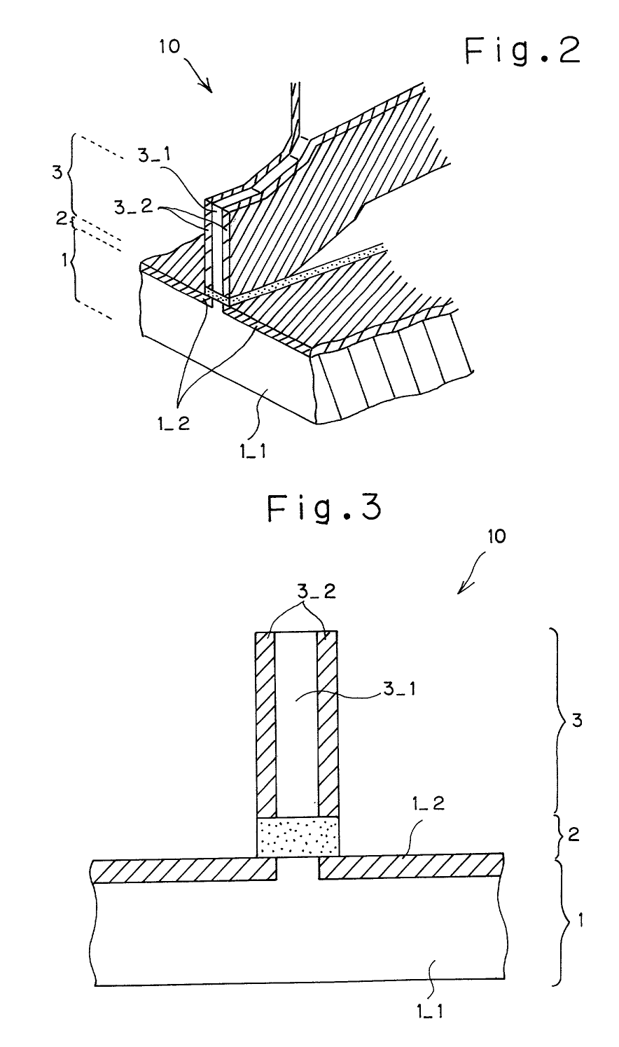

FIG. 2 shows a perspective view of the main section of the magnetic head according to the embodiment of the present invention. FIG. 3 shows a front view of the main section of the magnetic head according to the embodiment of the present invention. The term a “front” herein refers to the side of the magnetic head which faces the magnetic disk. The side of each element of the magnetic head seen from the “front” side will be hereinafter referred to as a “front” surface.

As described above, the magnetic head 10 is positioned adjacent to the magnetic disk 103 within the above-described HDD100. FIGS. 2 and 3 show the side of the recording means of the magnetic head 10 close to the magnetic disk 103. The front surface of the magnetic head 10 shown in FIG. 3 faces the magnetic disk 103.

The recording means of the magnetic head 10 has: a lower soft-magnetic pole 1; a gap layer 2 of non-magnetic insulting material formed on the lower magnetic pole 1; and upper soft-magnetic pole 3 formed on the gap layer 2.

The recording means of the magnetic head 10 has a recording coil (not shown) consisting of, for example, Cu on the side apart from the above-described floating surface between the lower magnetic pole 1 and upper magnetic pole 3. The recording coil is covered with an insulting material such as resist.

The upper magnetic pole 3 and the lower magnetic pole 1 forms a magnetic circuit which pass through the center of the recording coil and makes one turn around the recording coil at the side of the coil facing the magnetic disk 103. Magnetic field generated by the recording coil passes through the upper magnetic pole 3 and the lower magnetic pole 1, and flow out from the region which faces the magnetic disk 103, i.e., from around a region where the lower magnetic pole 1 and the tip of the upper magnetic pole 3 face each other. The flown-out magnetic field may reverse the direction of the magnetization of the individual small region on the above-described magnetic disk 103.

The regenerating means of the magnetic head is located on the side of the lower magnetic pole 1 of the recording means opposite from the upper magnetic pole 1.

The lower magnetic pole 1 is a magnetic pole of 3 μm thick which comprises Ni₅₀Fe₅₀ (at %) partly containing Nb therein.

The gap layer 2 is a layer of 1 μm thick consisting of Al₂O₃ (alumina) which is trimmed at the front to have a 0.5 μm front surface in the direction toward which the lower magnetic pole 1 extends. The upper magnetic pole 3 is a magnetic pole of 3 μm thick which comprises Ni₅₀Fe₅₀ (at %) partly containing Nb therein.

The upper magnetic pole 3 is generally in a tip of a block form that has a front wall facing the magnetic disk 103 and a pair of side walls which extend in a direction perpendicular to the front wall as well as the other in another direction toward the upper magnetic pole 3 is laminated. The front wall of the tip is 0.5 μm wide (width), along a direction the lower magnetic pole 1 extends, and the side walls of the tip is 3 μm wide (thickness) along a direction from the front surface to the back of the tip. The upper magnetic pole 3 has a configuration such that the distance between the side walls increases along the direction from the front to the back of the tip.

The upper magnetic pole 3 is generally composed of Ni₅₀Fe₅₀ and comprises: a pair of upper non-magnetic regions 3_2 which have been demagnetized by injecting Nb ions into the Ni₅₀Fe₅₀ up to the depth of 0.1 μm by means of, for example, ion-implantation; and an upper soft-magnetic portion 3_1 of Ni₅₀Fe₅₀ which remains free of Nb ions and sandwiched by the pair of upper non-magnetic regions 3_2 at the both sides.

Also, the lower magnetic pole 1 is generally composed of Ni₅₀Fe₅₀ and comprises: a pair of lower non-magnetic regions 1_2 which have been demagnetized by injecting Nb ions into the Ni₅₀Fe₅₀ up to the depth of 0.1 μm on the surface facing the upper magnetic pole 3 except a region other than the region just below the above-described upper soft-magnetic region 3_1; and the other region, i.e., a lower soft-magnetic region _1 consisting of Ni₅₀Fe₅₀ which remained free of Nb ions.

The magnetic width of the magnetic head 10, which is represented by the width of the upper soft-magnetic region 3_1, is smaller than the actual width of the tip of the upper magnetic pole 3, since the tip of upper magnetic pole 3 is demagnetized from both of the side walls to the respective predetermined depths by injecting impurity as described above. Since the region of the magnetic head 10 where a magnetic field is generated is defined by the magnetic width, then the magnetic head 10 has a very narrow core width. As will be described below by referring to a process for fabricating magnetic head, the magnetic width at the tip of the upper magnetic pole 3 has very accurately defined uniformity at any positions on the tip so that the core width of the magnetic head 10 is very accurately defined.

The dimensions such as thickness and width of lower magnetic pole 1, gap layer 2, and upper magnetic pole 3 which constitute the tip of the magnetic head 10 as well as other parts which constitute the lower magnetic pole 1 and the upper magnetic pole 3 may not be limited to the above-described parameters.

Alternatively, the above-described lower magnetic pole 1 and upper magnetic pole 3 may be composed of other soft-magnetic materials such as Ni₈₀Fe₂₀ (at %), CoNiFe and FeZrN besides Ni₅₀Fe₅₀, or may be a membrane composed of multiple layers each of which consists of such soft-magnetic material influding Ni₅₀Fe₅₀. The above-described gap layer 2 may consist of other non-magnetic insulting material rather than alumina.

Examples of ions to be injected in these magnetic poles include Nb, Cr and Zr.

Although the magnetic head according to the embodiment of the present invention is trimmed only at the upper magnetic pole 3 along the width direction as shown in FIGS. 2 and 3, the magnetic head can also be trimmed at the lower magnetic pole 1 according to the present invention.

Further, the magnetic head 10 according to the embodiment of the present invention has a tip of a simple configuration in which the side walls of the tip have no steps thereon, though the magnetic head can have more complicated configuration at the tip such as one in which the tip is trimmed to have a reduced width, or one in which the tip has, between the upper 3 and lower 1 magnetic poles, a pair of auxiliary magnetic poles having a smaller width than those of these two magnetic poles, according to the present invention. In these cases, the portion corresponding to the tip of the magnetic pole of the present invention may be such trimmed portion(s) of the tip having smaller width or such auxiliary magnetic poles themselves, or wider region including the trimmed portion(s) and/or the auxiliary magnetic poles.

Since the HDD100 according to the above-described embodiment is provided with a magnetic head 10 that has a very narrow core width accurately defined as described above, it is a suitable device for high density recording system which can accurately write information in each very narrow track on the magnetic disk 103.

[The Process for Fabricating Magnetic Head]

A process for fabricating magnetic head 10 will be described below along with the characteristic of the magnetic head 10 according to the above-described embodiment will be provided.

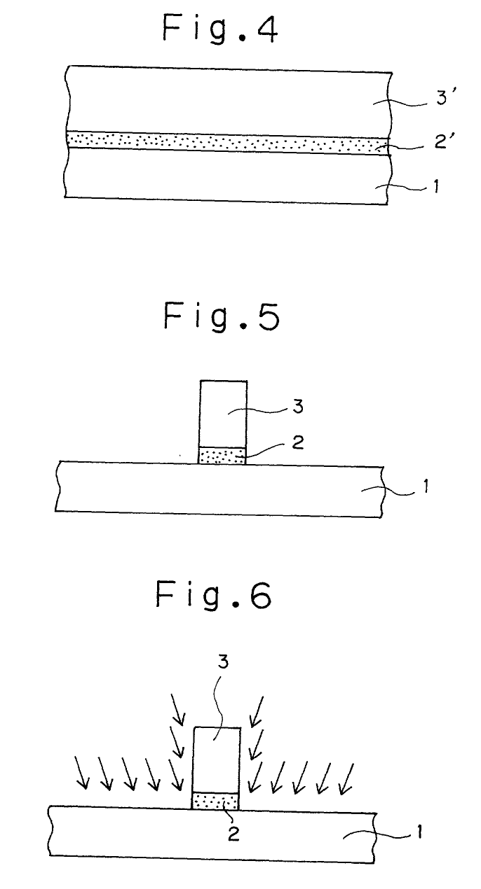

FIGS. 4-6 show the first to third steps of the process for fabricating magnetic head according to the present embodiment, respectively.

In the first step of the process for fabricating magnetic head according to the present embodiment, a multi-layered membrane is formed by: laminating an alumina gap layer 2′ of 1 μm thick on the lower Ni₅₀Fe₅₀ magnetic pole 1 of 3 μm thick which also serves as a magnetic shield layer in the regenerating means of the magnetic head 10 according to the present embodiment formed on a given substrate, by means of, for example, sputtering as shown in FIG. 4; and laminating an upper Ni₅₀Fe₅₀ magnetic pole layer 3′ of 3 μm thick on the gap layer 2′.

In the second step of the process for fabricating magnetic head according to the present embodiment, the gap layer 2′ and the upper magnetic pole 3′ in the multi-layered membrane obtained in the step 1 above are independently trimmed to form 0.5 μm wide gap layer 2 and the tip of the upper magnetic pole 3 as shown in FIG. 5 by, for example, etching using RIE (Reactive Ion Etching). Thus trimmed multi-layered membrane has the same feature as that of the magnetic head 10 shown in FIG. 3. The trimmed surface of the upper magnetic pole layer 3′ corresponds to the above-described side wall of the upper magnetic pole 3. Hereinafter the term “multi-layered membrane” refers to the trimmed multi-layered membrane.

In the second step, the upper magnetic pole 3 having a configuration as shown in FIG. 5 may be obtained by patterning resist on a thin coating film and then plating the resist, instead of using RIE process. Such trimming may reduce the widths of the upper magnetic pole layer 3′ and gap layer 2′ to about 0.5 μm when an i-ray stepper is used, or to about 0.3 μm when an excimer stepper is used.

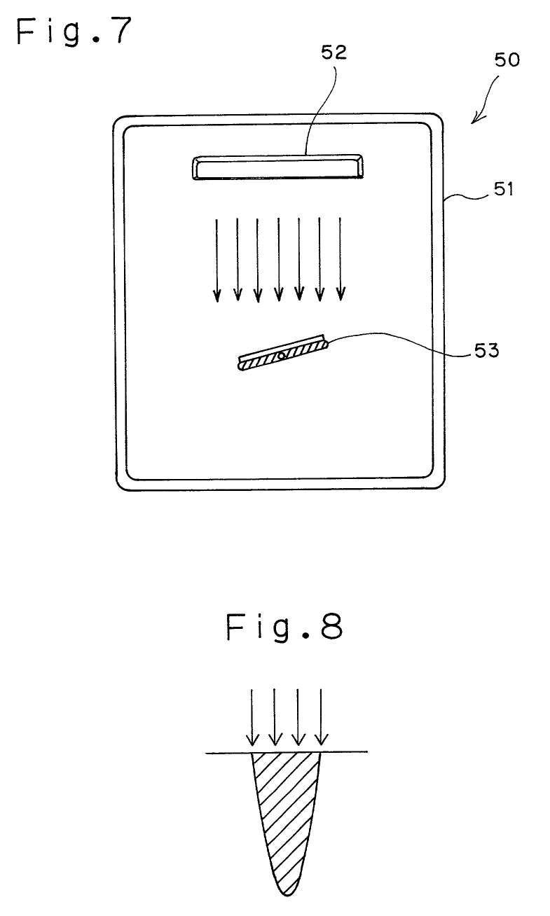

In the third step of the process for fabricating magnetic head according to the present embodiment, ions may be applied downwardly from above the multi-layered membrane formed in step 2, in an angled direction, not in a perpendicular direction, with respect to the above described substrate from the side of the substrate on which the multi-layered member has been laminated, as shown in FIG. 6. Thus, ions will be injected into the upper magnetic pole 3 through each surface of the multi-layered membrane including the side walls of the upper magnetic pole 3 by the ion-implantation process. The downward ion-implantation in an angled direction may be performed by using the ion-implantation device shown in FIG. 7.

FIG. 7 shows a schematic view of the ion-implantation device to be used in the process for fabricating magnetic head according to the present embodiment.

The ion-implantation device 50 comprises a chamber 51, an ion generator 52 for generating ions, and a substrate fixing member 53 for mounting the substrate having the above-described multi-layered membrane formed thereon. The arrows in FIG. 7 indicate the flow direction of ions generated from the ion generator 52. These ions are injected in the multi-layered membrane on the substrate mounted on the substrate fixing member 53. The substrate mounted on the substrate fixing member 53 shown in FIG. 7 is tilted into counterclockwise direction with respect to the line parallel to the direction the ion generator 52 extends in the drawing. The substrate fixing member 53 can be tilted to both clockwise and counterclockwise directions by the same angle around the vertical axis with respect to the drawing paper. The multi-layered membrane on the substrate will also tilted in combination with the tilting of the fitting member 53. The “vertical axis with respect to the drawing paper” means an axis which extends from the front to the back of the above-described multi-layered membrane. The tilting of the multi-layered membrane will expose a pair of side walls of the magnetic pole 3 in the multi-layered membrane to the ions generated from the ion generator, whereby ions are injected from these side walls.

The substrate fixing member 53 may be tilted to both clockwise and counterclockwise directions, or may be remained tilted to either direction to serve as the rotating axis vertical to the substrate to rotate the substrate. This rotation also allows ion-implantation through the side walls of the upper magnetic pole 3 in the above-described multi-layered membrane.

The magnetic head 10 as shown in FIGS. 2 and 3 can be formed by such ion-implantation into the multi-layered membrane. The upper non-magnetic pole 3 thus has the upper non-magnetic regions 3_2 formed by demagnetization by the ion-implantation through the side walls thereof. Ions generated from the ion generator 52 will be also injected into the lower magnetic pole 1 as well as the upper magnetic pole 3. Thus, the lower magnetic pole 1 also has lower non-magnetic regions 1_2 formed by demagnetization by the ion-implantation through the upper surface thereof, i.e., the surface on the side which is close to the upper magnetic pole 3.

Examples of ions to be injected to the magnetic pole for partial demagnetization are Nb, Cr and Zr. When Nb is injected into an NiFe film, for example, the saturation magnetic flux density of the film of 0 was attained by adding 15 at % Nb. From the result, the amount of ions to be injected per unit area required for attaining the saturation magnetic flux density of 0 can be estimated to be about 5×10¹⁶/cm³ to about 1×10¹⁷/cm³. The depth to which ions are to be injected is about 150 nm or about 200 nm when ions are injected in a vertical direction with respect to the surface at an energy of 300 KeV or 400 KeV, respectively.

Preferably, the regions of the magnetic pole where ions have been injected for demagnetization may ideally have a saturation magnetic flux density of 0 though other saturation magnetic flux density may be employed provided that the density is sufficiently small to substantially demagnetize the ion-injected regions as disclosed in JP-A-5-189720.

For deep ion-implantation, energy retained by the ions to be injected will be increased and/or the angle at which the ions is injected will be closer to a direction perpendicular to the side walls. For not so deep ion-implantation, ion energy may be reduced and/or the injection angle of ions may be made closer to parallel to the surface.

It should be noted that the angle between the side wall and the direction of ion-implantation is desirably within a range from 20° to 85°. Sufficiently deep ion injection will not be attained when the angle of smaller than 20° is employed. Alternatively, the magnetic pole will be subjected to contamination generated from the adjacent device(s) when ions are injected at an angle lager than 85°.

After a magnetic pole of about 0.5 μm wide is fabricated by means of, for example, i-ray stepper, the magnetic pole may be demagnetized by injecting ions through the respective side walls of the magnetic pole to a depth of 100 nm in order to reduce the magnetic width of the magnetic pole to 0.3 μm. When the ions to be injected have an energy of 300 KeV, the magnetic pole can be demagnetized in a region from the side walls to 100 nm deep by injecting ions at an angle of about 60° from the side walls.

When ant excimer stepper is employed in the head producing process to form a magnetic pole of 0.3 μm wide, a magnetic pole having a magnetic width of as small as 0.1 μm can be formed by using the same condition as described for ion-implantation for fabricating the above-described magnetic pole of 0.5 μm wide having a magnetic width of 0.3 μm.

The characteristics of the process for fabricating magnetic head according to the present embodiment will be described by comparing with a conventional process for fabricating magnetic head.

Conventional magnetic poles have a narrow tip refined by physical or chemical process. However, an accurate shaping of a minute tip of a magnetic pole is difficult by such processes, and a magnetic head substantially having such an inaccurately-shaped minute tip may have varied width depending on points on the tip, and thus may have a core width defined with low accuracy.

For example, when etching is employed to reduce the width of the tip of a magnetic head, it will be difficult to attain an accurate alignment of mask for defining the etching positioning and a uniform depth of etching region along the side walls. An ion-milling process may also be used to reduce the width of the tip of a magnetic head, instead of ion-implantation though it cannot uniformly reduce the depth width of the tip since the ion-milling process will excessively remove the corner of the tip by repeated ion attacking to the corner to round the corner (face-off) or cause blind over edging. Accordingly, a narrow tip with a uniform width cannot be obtained by ion-milling process.

To the contrary, the magnetic head 10 according to the present embodiment that is produced by the process for fabricating magnetic head according to the present invention has ions introduced through the side walls to a particular depth. The depth of the region into which ions have been introduced is determined by the energy of ions to be introduced and the angle at which ions are applied. Accordingly, if the above-described side walls of the tip is flat, then the interface between the upper soft-magnetic region 3_1 and upper non-magnetic region 3_2 is flat. Therefore, the core width, which is determined by the width of the upper soft-magnetic region 3_1, is very accurately defined even though the tip is too narrow.

Conventionally, processes for partly demagnetizing a magnetic pole per se are known wherein impurities are injected into the magnetic pole by ion-implantation as in the process for fabricating magnetic head according to the present invention. For example, JP-A-8-7223 and JP-A-7-114709 disclose processes for forming a magnetic disk in to have an improved noise property by selectively injecting impurities into the magnetic disk from the recording surface using a mask. It should be noted that a mask should be employed for impurity injection by using any conventional ion-implantation processes as those described in these literatures. Hereinafter, the magnetic head 10 produced by the process for fabricating magnetic head according to the present embodiment will be described by comparing with a conventional magnetic head produced by ion-implantation using a mask.

FIG. 8 shows a diagram illustrating a distribution of ions injected by ion-implantation.

FIG. 8 illustrate an ion-implantation where ions are injected perpendicular to the surface of the thin film. The direction of ion-implantation is indicated by downward arrows. In this Figure, ions are injected into a limited region of the film by using a mask or the like. FIG. 8 also shows a cross sectional view of the thin film illustrating the region thereof in which ions have been injected by the hatched area (ion distribution). As can be seen from the drawing, the film has a non-uniform ion distribution such that the ion-injected region is tapered off at its bottom end. In other words, ions are injected deeply in the middle area of the above-described limited region while they are not in its peripheral area. Similarly, when the limited region is large, the ion-injected region has a uniform depth in the middle area of the limited region, which the depth is defined by the energy retained by the ions injected, (i.e., uniform ion distribution may be obtained at the middle area of the limited region), though ion-injection will be more shallow in its surrounding area.

The depth to which ions are injected in a material is determined by the energy of the ion to be injected, and the density of ions injected is determined by the amount of ions to be injected, as described above.

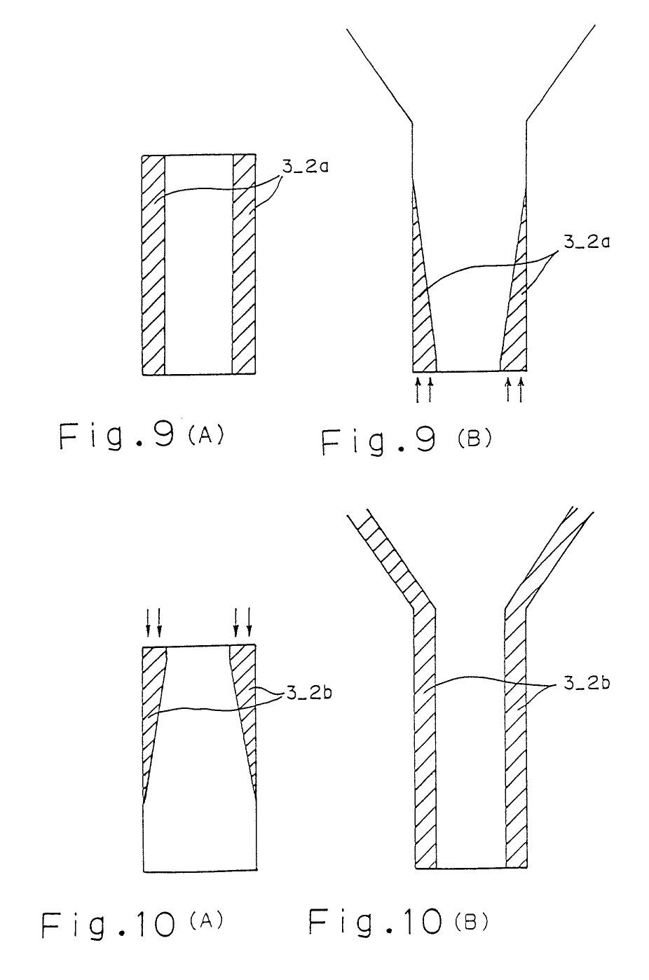

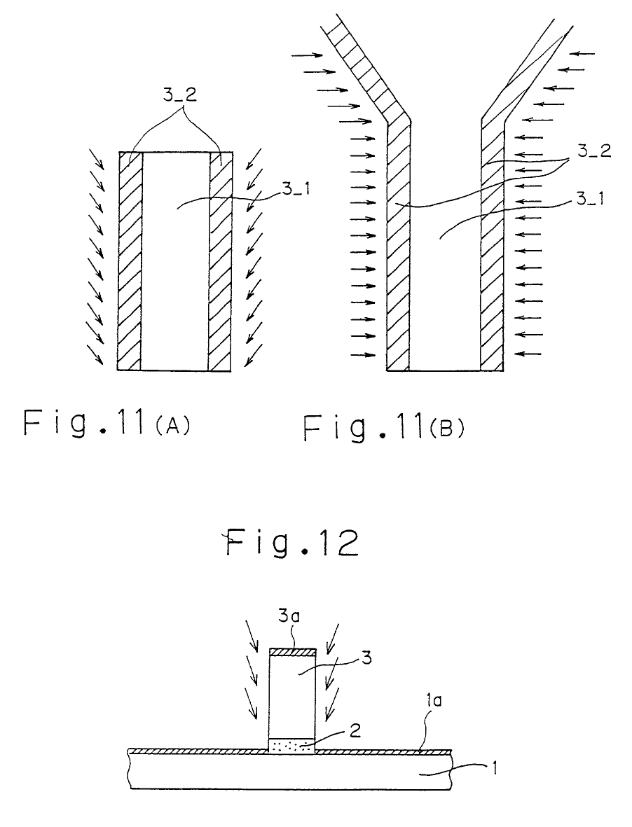

FIGS. 9(A) and 9(B) each shows a front view (A) and a top view (B) of the tip of an upper magnetic pole into which ions are injected from the front side by using a mask, respectively. FIGS. 10(A) and 10(B) each shows a front view (A) and a top view (B) of the tip of an upper magnetic pole into which ions are injected from the top by using a mask, respectively. FIGS. 11(A) and 11(B) each shows a front view (A) and a top view (B) of the tip of an upper magnetic pole into which ions are injected by using the process for fabricating magnetic head according to the present embodiment, respectively.

Arrows indicate the direction of ions-implantation, and hatched areas are the regions into which ions have been implanted in FIGS. 9(A)-11(B).

As shown in FIG. 9(A), non-magnetic regions 3_2a having a predetermined width can be formed on the front wall of the tip along at the rims adjacent to the side walls, as described for the upper non-magnetic portion 3_2 of the upper magnetic pole 3, by ion-implantation using a mask into the front wall of the tip (i.e., the side of the tip of the upper magnetic pole adjacent to the magnetic disk 103).

However, the demagnetized regions 3_2a are gradually tapered off toward the back of the tip, which means that the depth of the ion-implanted regions of the tip varies depending on points. This causes varied thickness of the soft-magnetic regions depending on places, resulting in unsuccessful definition of accurate core width.

On the other hand, a pair of non-magnetic regions 3_2b, which have been demagnetized to a predetermined distance from the side walls, can be formed by injecting ions from the top of the tip upper magnetic pole using a mask, which have the same configuration as that of the above-described non-magnetic regions 3_2 of the upper magnetic pole when seen from the top as shown in FIG. 10(A).

However, these demagnetized regions 3_2b are tapered off toward the substrate beneath the magnetic pole as shown in FIG. 10(B), i.e., ion distribution is tapered off toward the bottom, which means that the depth to which ions have been injected varies depending on places on the tip. Therefore, the core width cannot be defined accurately due to the varied width of the soft-magnetic regions of the magnetic pole.

Moreover, a distance to which the magnetic pole can be demagnetized from the front or top wall by such ion-implantation process using a mask is as small as hundreds nanometers. Therefore, it is difficult to demagnetize the tip of the magnetic pole over a broad side walls when the tip has a height (the distance from the top to the bottom) or a thickness (the distance from the front to the back) of several micrometers. Further, an accurate alignment of mask is required. For these reasons, it is impossible to refine a minute magnetic pole by these processes using a mask.

Unlike these processes shown in FIGS. 9(A), 9(B), 10(A) and 10(B), and 10, the ion-implantation process employed in the process for fabricating magnetic head according to the present embodiment, shown in FIGS. 11(A) and 11(B), does not require a mask. Since this process is of self-alignment type where ions are introduced into the tip of the upper magnetic pole 3 through each of the pair of side walls, ions can be accurately introduced in a desired place on the tip. In this process, ions are applied downwardly in an angled direction with respect to each of the side walls when seen from the front of the tip, as shown by the arrows in FIGS. 11(A) and 11(B).

Such ion-implantation provide a uniform thickness (a distance from the front to the back) and depth (a distance from the top from the bottom) of ion-injected regions as shown in FIGS. 11(A) and 11(B), respectively. Such thickness or depth may be determined by the energy of ions to be injected and the angle at which ions are applied, with little deviations. Particularly, the magnetic head 10 according to the present embodiment has a deviation of within ±5% in the width of the upper non-magnetic regions 3_2 demagnetized by the ion-implantation process (i.e., the distance to which ions have been introduced from each of the side walls) when the side walls have a height (i.e., the length from the top to the bottom of the tip) of at least 0.3 μm or more.

The magnetic head 10 produced by the ion-implantation according to the present embodiment has a small deviation in the depth of ion-implantation and thus a small deviation in the width of the upper soft-magnetic regions 3_1, thereby defining an accurate core width.

Further, broader side walls can be demagnetized by an ion-implantation through the side walls such as one employed in the process for fabricating magnetic head according to the present embodiment. Particularly, the magnetic head 10 according to the present embodiment may be provided with a tip having a height of 0.3 μm or more (i.e., 0.3 μm long or more in the laminating direction), or a thickness of 1 μm or more (i.e., 1 μm thick or more along the direction perpendicular to the surface of the magnetic disk 103).

JP-A-5-189720 discloses a process for demagnetizing unnecessary regions by selectively introducing impurities in the lower magnetic pole using the upper magnetic pole as a mask. This process enables the formation of a lower magnetic pole having a substantially small magnetic width by demagnetizing the lower magnetic pole without refining. This process does not require an accurate alignment of mask since it employs the upper magnetic pole as a mask. In this process, however, not only some refinement process of the minute upper magnetic pole is required but also the width of the lower magnetic pole which can be obtained by this process depends on the width of the upper magnetic pole.

FIG. 12 shows an exemplary method for fabricating magnetic head according to the present invention.

FIG. 12 shows a process for fabricating magnetic head by demagnetizing only the side walls of the tip of the magnetic pole. In this case, the upper magnetic pole 3 and gap layer 2 are formed by trimming the upper magnetic layer 3′ and gap layer 2′ in the second step of the process for fabricating magnetic head according to the above-described embodiment of the present invention and then, depositing Al film or the like of a thickness from 30 nm to 50 nm from above in a direction opposite from the laminate direction along the side walls of the upper magnetic pole 3 by using directional sputtering (colimation sputtering, long slow sputtering or the like). The directional sputtering may form an Al film 1a of a desired thickness from 30 nm to 50 nm and another Al film 3a of the same thickness on the top surfaces of the lower magnetic pole 1 and of the upper magnetic pole 3, respectively. However, the thickness of the Al films which can be formed on the side walls of the tip are almost nothing.

As described above, when ions are applied downwardly in an angled direction to the side walls after Al films are formed, ions can be injected through the side walls of the upper magnetic pole 3 to a desired depth though almost no ions are introduced through the top surfaces of the lower magnetic pole 1 and upper magnetic pole 3.

The Al film can be removed by immersing in an alkaline liquid developer after ion-implantation. Examples of elements which can be removed by a liquid developer include Al and Zn. Accordingly, Zn can be used instead of Al for preserving the region other than the side walls from such ion-implantation. Further, the Al film can also be removed by dry etching using chlorine gas plasma etching device after ion-implantation. Examples of materials which can be removed by dry etching process are Al and TiN. Accordingly, TiN film can be used instead of the above-described Al film.

As described above, the process for fabricating magnetic head according to the present embodiment can provide a magnetic pole having a core width substantially smaller than that of magnetic pole which has been physically and chemically formed by using conventional stepper. For example, a magnetic pole having a width smaller than 0.3 μm, which is the resolution limit of the KrF excimer stepper, can be provided. Controlling the smaller width of magnetic pole by a conventional stepper alignment may have an increased possibility of misregistration. To the contrary, the process for fabricating magnetic head according to the present embodiment will not produce such misregistration, reduce the number of steps involved in the process and improve the accuracy of core width. This process can also provide uniformly reduced thickness, height and width of the magnetic region of a magnetic pole by applying ions downwardly to the magnetic pole or poles in an angled direction with respect to the side walls of thereof to introduce ions therethrough.

As described hereinbefore, the present invention can provide a magnetic head having an accurately defined minute core width, a process for fabricating the magnetic head, and an information recorder having the magnetic head.

What is claimed is:

1. A magnetic head comprising a pair of soft-magnetic poles which are positioned adjacent to or in contact with the recording medium and opposed to and apart from each other with a predetermined distance in a predetermined direction wherein:
the soft-magnetic poles generate a magnetic field therebetween to magnetize the recording medium; and
at least one of the two magnetic poles has a tip of a block form adjacent to or in contact with the recording medium, the tip having a front wall adjacent to or in contact with the recording medium and a pair of side walls which extend in a direction perpendicular to the front wall as well as in the above-described predetermined direction, the tip having a non-magnetic region demagnetized by introducing impurities through each of the side walls to a predetermined depth.

2. The magnetic head according to claim 1 wherein said tip has a dimension of 0.3 μm or more along said predetermined direction.

3. The magnetic head according to claim 1 wherein said tip has a dimension of 1 μm or more along the direction perpendicular to the surface of said recording medium.

4. The magnetic head according to claim 1 wherein the deviation in the depth of the demagnetized region from each of the side walls is within ±5% when the side walls of the above-described tip of a block form has a dimension of 0.3 μm or more at least along said predetermined direction.

5. A process for fabricating a magnetic head comprising a pair of soft-magnetic poles which are positioned adjacent to or in contact with the recording medium and opposed to and apart from each other with a predetermined distance in a predetermined direction wherein the soft-magnetic poles generate a magnetic field therebetween to magnetize the recording medium, the process comprising the steps of:
forming one of the two magnetic poles, an upper magnetic pole having, at one end adjacent to or in contact with the recording medium, a tip of a block form that has a front wall which is adjacent to or in contact with the recording medium and a pair of side walls which extend in a direction perpendicular to the front wall as well as in the above-described predetermined direction; and
partly demagnetizing the upper magnetic pole formed in the step for forming upper magnetic pole by introducing ions through each of the side walls of the tip of the upper magnetic pole using ion-implantation.

6. The process according to claim 5 wherein said demagnetizing step is performed by introducing ions into said tip by applying ions downwardly to each of the side walls in an angled direction with respect to said side walls.

7. The process according to claim 5 which further comprises the steps of forming the other magnetic pole, the lower magnetic pole, wherein said demagnetizing step is performed by the ion-implantation into the tip through the side walls as well as into the lower magnetic pole at the same time by using an ion generator.

8. The process according to claim 5 which further comprises the steps of:
forming the other magnetic pole, the lower magnetic pole;
forming a protecting film on at least one of the top surface of the tip of the upper magnetic pole (i.e., the surface of the tip which faces opposite from said lower magnetic pole) and the top surface of the lower magnetic pole (i.e., the surface of the lower magnetic pole facing the upper magnetic pole); and
separating the protecting film or films formed in the step for forming a protecting film from the magnetic pole or poles; wherein the ion-implantation of said demagnetizing step is performed after the step for forming a protecting film, followed by the step for separating the protecting film.

9. An information recorder comprising a magnetic head that is located adjacent to or in contact with a recording medium, which retains magnetization in individual small regions on its surface, and can reverse the direction of the magnetization on the recording medium to record the information in the individual small regions on the recording medium, wherein:
the magnetic head comprises a pair of soft-magnetic poles which are positioned adjacent to or in contact with the recording medium and opposed to and apart from each other with a predetermined distance in a predetermined direction, the soft-magnetic poles generate a magnetic field therebetween to magnetize the recording medium; and
at least one of the two magnetic poles has a tip of a block form adjacent to or in contact with the recording medium, the tip having a front wall adjacent to or in contact with the recording medium and a pair of side walls which extend in a direction perpendicular to the front wall as well as in the above-described predetermined direction, the tip having a non-magnetic region demagnetized by introducing impurities through each of the two side walls to a predetermined depth.
